(19) United States
(12) Patent Application Publication
(10) Pub. No.: US 2025/0367761 A1
(43) Pub. Date: Dec. 4, 2025

(54) LASER INDUCED ELECTROCHEMICAL DEPOSITION FIVE-AXIS ADDITIVE MANUFACTURING DEVICES AND METHODS THEREOF

(71) Applicant: CHANGCHUN UNIVERSITY OF SCIENCE AND TECHNOLOGY, Changchun (CN)

(72) Inventors: Jinkai XU, Changchun (CN); Wanfei REN, Changchun (CN); Zhaoqiang ZOU, Changchun (CN)

(73) Assignee: CHANGCHUN UNIVERSITY OF SCIENCE AND TECHNOLOGY, Changchun (CN)

(21) Appl. No.: 18/759,794

(22) Filed: Jun. 28, 2024

(30) Foreign Application Priority Data
Jun. 4, 2024 (CN) 202410713669.9

(51) Int. Cl. B23K 26/342; B23K 26/03; B23K 26/046; B23K 26/06; B33Y 10/00; B33Y 30/00; B33Y 50/02

(52) U.S. Cl. CPC B23K 26/342; B23K 26/032; B23K 26/034; B23K 26/046; B23K 26/0648; B33Y 10/00; B33Y 30/00; B33Y 50/02

(57) ABSTRACT

A laser induced electrochemical deposition five-axis additive manufacturing device and a method are provided. The device includes: a housing, together with a main support component, a displacement control component, an electrode component, and a coupling component that are disposed inside the housing. The displacement control component is fixed to the main support component, and is configured to control the coupling component to move in a third direction, and/or control a partial structure of the electrode component to move in a first direction and a second direction, and to rotate about the first direction and the third direction; and the electrode component and the coupling component are both fixedly connected to the displacement control component; the coupling component and the electrode component are mounted in sequence on the displacement control component along the third direction.

### TECHNICAL FIELD

The present disclosure relates to a technical field of electrochemical deposition additive manufacturing, in particular, to a laser induced electrochemical deposition five-axis additive manufacturing device and a method thereof.

### BACKGROUND

With the continuous development of micro-nano technology, a demand for a high-precision, high-speed, and high-quality micro-nano manufacturing technology is becoming more and more urgent. Traditional micro-nano manufacture technologies, such as photolithography, electroplating, etc., have certain limitations and are unable to meet the requirements for a preparation of complex structures. A localized electrochemical deposition is a commonly used technique for a preparation of the micro-nano structure with an ability to manufacture three-dimensional (3D) complex micro-nano structured parts. The localized electrochemical deposition may control a composition and crystal structure of a material by adjusting a potential, a current density, and other parameters, but the processing efficiency and the quality of the localized electrochemical deposition need to be further improved. A laser processing technology, as a high-precision and high-efficiency material processing technology, has been widely used in a field of micro-nano processing, but it is deficient in manufacturing complex microstructures. With a continuous development of a laser technology, a precision and a speed of the laser processing technology have been significantly improved, which provides a potential technical support for the localized electrochemical deposition technology. Due to features of an instantaneous high power and non-contact processing of the laser technology, a composite deposition technology of the laser and electrochemical can be realized. However, at present, due to a difficulty of a process of a laser and electrochemical composite deposition, the composite deposition technology may only be applied in a laser and electrochemical processing of a plane coating. A great challenge still exists for the manufacture of 3D complex structural parts.

Therefore, a laser induced electrochemical deposition five-axis additive manufacturing device and a method thereof are provided, which helps to realize an efficient and high-quality manufacturing of 3D complex structural parts.

### SUMMARY

Embodiments of the present disclosure provide a laser induced electrochemical deposition five-axis additive manufacturing device. The device may include: a housing together with a main support component, a displacement control component, an electrode component, and a coupling component that are disposed inside the housing. The displacement control component may be fixed to the main support component, and may be configured to control the coupling component to move in a third direction, and/or control a partial structure of the electrode component to move in a first direction and a second direction, and to rotate about the first direction and the third direction. The electrode component and the coupling component may be both fixedly connected to the displacement control component. The coupling component and the electrode component may be mounted in sequence on the displacement control component along the third direction.

Some embodiments of the present disclosure provides a method for laser and electrochemical deposition. The method may include: connecting a working electrode, a reference electrode, and a counter electrode of an electrochemical workstation to a working electrode terminal, a reference electrode terminal, and a counter electrode terminal of an electrolytic cell body correspondingly via signal connection lines for electrochemical deposition.

Some embodiments of the present disclosure provide a controlling method for laser induced electrochemical deposition. The method may be performed by a controller. The method may include: determining a processing parameter, the processing parameter including at least one of a moving route, at least one processing position and corresponding position information, and a laser processing parameter; determining at least one group of control instructions based on the processing parameter, and controlling operation of at least one of a displacement control component, an optical coupling cavity, an angle adjustment component, and a displacement adjustment component based on the at least one group of control instructions for electrochemical deposition.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same counting denotes the same structure, wherein:

FIG. 1 is a schematic diagram illustrating an exemplary overall structure of a laser induced electrochemical deposition five-axis additive manufacturing device according to some embodiments of the present disclosure;

FIG. 2 is a main cross-sectional view illustrating an exemplary laser induced electrochemical deposition five-axis additive manufacturing device according to some embodiments of the present disclosure;

FIG. 3 is a side cross-sectional view illustrating an exemplary laser induced electrochemical deposition five-axis additive manufacturing device according to some embodiments of the present disclosure;

FIG. 4 is a schematic diagram illustrating an exemplary optical path connection within an optical coupling cavity according to some embodiments of the present disclosure;

FIG. 5 is a flowchart illustrating an exemplary controlling method for a laser induced electrochemical deposition according to some embodiments of the present disclosure;

FIG. 6 is a schematic diagram illustrating an exemplary laser angle model according to some embodiments of the present disclosure; and

FIG. 7 is a schematic diagram illustrating an exemplary angle adjustment model according to some embodiments of the present disclosure.

### DETAILED DESCRIPTION

To more clearly illustrate the technical solutions of the embodiments of the present disclosure, the following will briefly introduce the accompanying drawings that need to be used in the description of the embodiments. Obviously, the accompanying drawings in the following description are only some examples or embodiments of the present disclosure, and it is possible for a person of ordinary skill in the art to apply the present disclosure to other similar scenarios based on these drawings without creative labor. Unless obviously obtained from the context or the context illustrates otherwise, the same numeral in the drawings refers to the same structure or operation.

It should be understood that the terms “system,” “device,” “unit” and/or “module” as used herein are a way to distinguish different components, elements, parts, sections, or assemblies at different levels. However, the words may be replaced by other expressions if other words accomplish the same purpose.

As shown in the present disclosure and the claims, unless the context clearly suggests an exception, the words “a,” “one,” “an” and/or “the” do not specifically refer to the singular and may include the plural. Generally, the terms “including” and “comprising” only suggest the inclusion of clearly identified steps and elements that do not constitute an exclusive list, and the method or apparatus may also include other steps or elements.

Flowcharts are used in the present disclosure to illustrate operations performed by a system in accordance with some embodiments of the present disclosure. It should be understood that the preceding or following operations are not necessarily performed in an exact sequence. Instead, steps may be processed in reverse order or simultaneously. Also, it may be possible to add other operations to these processes or remove a step or steps from them.

A localized electrochemical deposition refers to a process of depositing a three-dimensional (3D) structure by space scanning in a plating bath using a micro-anode. Metal ions in the plating bath are precipitated out of a solution under an action of three electrodes to form metal atoms that enter a metal cell to be deposited as a solid. Currently, a process of localized electrochemical deposition is generally characterized by a low deposition rate, a poor structural density, and a poor surface quality of a deposited body. Using a thermal effect of a laser to assist the localized electrochemical deposition may improve a fixed-domain property and a purity of the deposited body, and in the current laser electrochemical composite processing technology, a main role of the laser is to enhance and induce an electrochemical reaction. But composite efficiencies of laser energy and a electrochemical reaction are not ideal, especially in the manufacture of 3D complex structural parts, manufacturing efficiency and manufacturing quality are low.

In view of the foregoing, some embodiments of the present disclosure provide a laser induced electrochemical deposition five-axis additive manufacturing device and a method, which uses an advantage of the electrochemical deposition for manufacturing the 3D structural parts, a feature of a contactless processing, and an instantaneous high power of the laser. The laser induced electrochemical deposition five-axis additive manufacturing device and method provides an effective solution with a broad applicability to a tiny scale manufacturing need of metal structures.

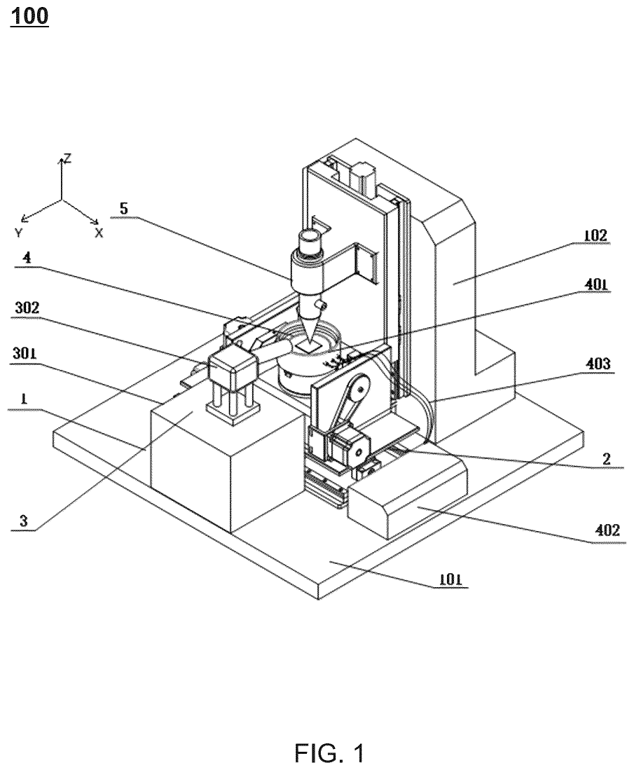

FIG. 1 is a schematic diagram illustrating an exemplary overall structure of a laser induced electrochemical deposition five-axis additive manufacturing device according to some embodiments of the present disclosure.

Some embodiments of the present disclosure provide the laser induced electrochemical deposition five-axis additive manufacturing device (hereinafter referred to as the additive manufacturing device) applied in various fields requiring manufacture of 3D complex structural parts. For example, in the field of microelectronics, the additive manufacturing device may be used to manufacture a high-density circuit board and a complex integrated-circuit structure, thereby achieving a micrometer-level or even a nanometer-level precision. For another example, an optical super surface, which is a two-dimensional (2D) array consisting a sub-wavelength structure, may allow for a precise manipulation of light waves. The additive manufacturing device may be used to manufacture these complex micro-nano structures for a development of new optical devices and systems.

As shown in FIG. 1, an additive manufacturing device 100 may include a housing, together with a main support component 1, a displacement control component 2, an electrode component 4, and a coupling component 5 that are disposed inside the housing. The displacement control component 2 is fixed to the main support component 1, and is configured to control the coupling component 5 to move in a third direction, and/or control a partial structure of the electrode component 4 to move in a first direction and a second direction, and to rotate about the first direction and the third direction. The electrode component 4 and the coupling component 5 are both fixedly connected to the displacement control component 2. The coupling component 5 and the electrode component 4 are mounted in sequence on the displacement control component 2 along the third direction.

The housing is an external protective structure of the additive manufacturing device 100.

In some embodiments, the housing may be made of a high-strength, corrosion-resistant metal material, such as a stainless steel or an aluminum alloy.

In some embodiments, the housing may be an open or closed metal frame, or the housing may also be a box structure.

The above descriptions related to the housing are for illustrative purposes only and are not intended to limit the scope of the present disclosure.

The main support component 1 refers to a structure that is mounted inside the housing of the additive manufacturing device 100, which provides solid support for the other components of the additive manufacturing device 100, such as the displacement control component 2, the electrode component 4, and the coupling component 5.

In some embodiments, the main support component 1 may include a work platform provided inside the housing.

In some embodiments, the main support component 1 includes: an optical vibration isolation platform 101 and a gantry 102.

The optical vibration isolation platform 101 is a work platform for isolating and minimizing effects of external vibrations on a performance of the additive manufacturing device 100.

In some embodiments, the optical vibration isolation platform 101 may isolate and reduce the external vibrations adopting manners of an air suspension, a magnetic levitation, or a mechanical spring, etc. For example, the optical vibration isolation platform 101 may include a vibration isolation base and a vibration isolation component (e.g., a coil spring, a rubber cushion, or an air cushion), and the vibration isolation base may be mounted inside the housing via the vibration isolation component.

The gantry 102 refers to an assembly that provides support and positioning functions. For example, the gantry 102 may be provided with mounting points and positioning holes to facilitate mounting and adjusting other components, such as a mobile platform and other devices.

In some embodiments, the gantry 102 may consist of at least one vertical column (or strut) and at least one beam. A structure of the gantry may also adapt to an actual form of the components it supports, which is not limited here.

In some embodiments, the gantry 102 is fixedly mounted to the optical vibration isolation platform 101. Manners of fixed mounting include, but are not limited to, a threaded connection, welding, etc.

According to some embodiments of the present disclosure, the optical vibration isolation platform is able to effectively isolate the external vibrations, and the gantry not only provides the necessary vertical and horizontal support, but also ensures structural stability and rigidity of the entire additive manufacturing device when performing a great-size or heavy-load processing. The gantry reduces deformation during processing and improves processing efficiency and finished product quality.

The displacement control component 2 is a component for controlling the movement of a portion of components of the additive manufacturing device 100, such as the electrode component 4 or the coupling component 5, in a plurality of directions. The movement in a plurality of directions at least includes the movement in the first direction, the second direction, and the third direction. The first direction, the second direction, and the third direction are directions of coordinate axes established based on the additive manufacturing device 100. As shown in FIG. 1, the first direction is a direction of a first side of the optical vibration isolation platform 101 (i.e., a direction of an X-axis), the second direction is a direction of a second side of the optical vibration isolation platform 101 (i.e., a direction of a Y-axis). The first side and the second side are perpendicular to each other. The third direction is a direction perpendicular to a plane of the optical vibration isolation platform 101 (i.e., a direction of a Z-axis).

In some embodiments, the displacement control component 2 may be a five-axis displacement control component. The five-axis displacement control component may control the movement of a portion of the component of the additive manufacturing device 100 (e.g., the electrode component 4 or the coupling component 5) in five directions. As shown in FIG. 1, the five-axis displacement control component may control the portion of the component of the additive manufacturing device 100 to move in the X-axis direction (i.e., the first direction), in the Y-axis direction (i.e., the second direction), in the Z-axis direction (i.e., the third direction), or to move around the Z-axis direction, and around the X-axis direction shown in FIG. 1.

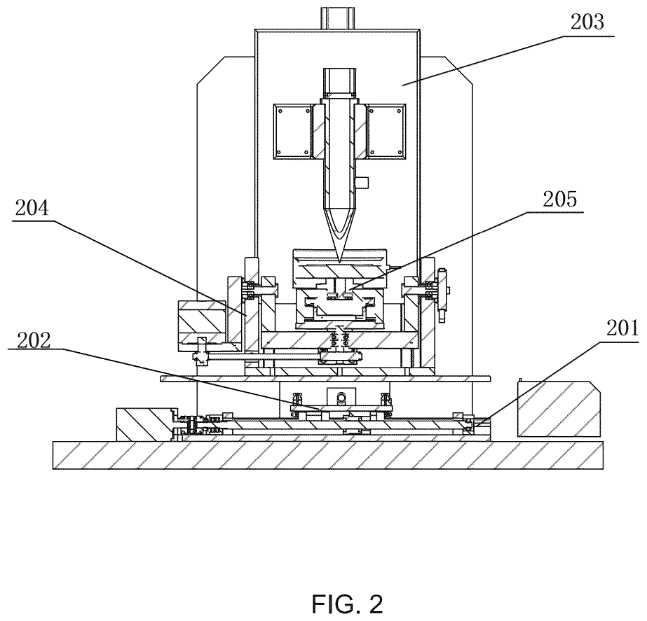

In some embodiments, the displacement control component 2 may include: a first moving platform 201, a second moving platform 202, a third moving platform 203, a first rotating platform 204, and a second rotating platform 205. For more contents of this embodiment, please refer to relevant descriptions in FIG. 2.

The electrode component 4 is a component for accomplishing an electrochemical reaction. For example, the electrode component 4 may include one or more electrode pairs.

In some embodiments, the electrode component 4 is fixedly connected to the displacement control component 2. Manners of the fixed connection include, but are not limited to, the threaded connection, the welding, a riveting, etc.

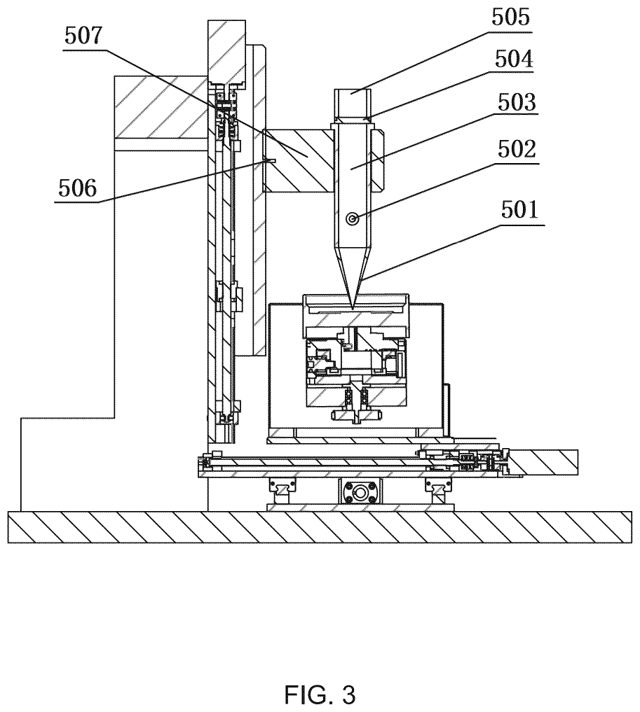

In some embodiments, the electrode component 4 may consist an electrolytic cell body 401, an electrochemical workstation 402, and a signal connection line 403. For more contents on this embodiment, please refer to the relevant descriptions in FIG. 3.

In some embodiments, the displacement control component 2 may control a partial structure of the electrode component 4 to move in the first direction, the second direction, and to rotate about the first direction and the third direction. For more contents on this embodiment, please refer to the relevant descriptions in FIG. 2.

The coupling component 5 is a device or system that controls an irradiation process and an electrochemical reaction process of the laser, either synchronously or alternately.

In some embodiments, the coupling component 5 and the electrode component 4 may be mounted in a top-to-bottom sequence on the displacement control component 2 along the third direction.

In some embodiments, the displacement control component 2 may control the coupling component 5 to move in the third direction. For more contents on this embodiment, please refer to the relevant descriptions in FIG. 2.

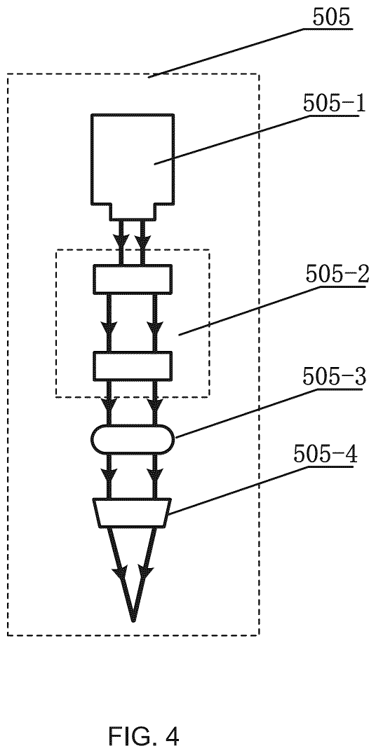

In some embodiments, the coupling component 5 may include: a coupling cavity fixture 507 and an optical coupling cavity 505, a first focusing lens 504, an electrolyte reservoir 503, and a probe 501 disposed in sequence in the third direction. For more contents on this embodiment, please refer to the relevant descriptions in FIG. 4.

According to some embodiments of the present disclosure, the additive manufacturing device is able to move along three linear directions (the first direction, the second direction, and the third direction) and to rotate about two of the directions (e.g., the first direction and the second direction, or the first direction and the third direction, etc.), which is conducive to carrying out a deposition operation on various complex geometries, thereby greatly expanding scope of application of the additive manufacturing for a wider range of parts and structural designs. The additive manufacturing of microstructures with a localized electrochemical deposition may be realized through a 3D complex motion control, which significantly improves the processing efficiency of the process while ensuring a processing quality.

In some embodiments, the additive manufacturing device 100 further includes a visualization component 3, as shown in FIG. 1.

The visualization component 3 is used to capture and display visual information about the laser and electrochemical composite deposition process inside the additive manufacturing device 100. For example, the visualization component 3 may capture and display an image or a video of the reaction region in real-time.

In some embodiments, the visualization component 3 may include an imaging component. The imaging component may include a microscope, a camera, a webcam, a thermal imaging camera, etc.

In some embodiments, the visualization component 3 is mechanically connected to the optical vibration isolation platform 101. For example, the visualization component 3 may be fixed to the optical vibration isolation platform 101 by welding, threading, etc.

In some embodiments, the visualization component 3 includes: a camera stand 301 and a camera 302.

In some embodiments, the camera stand 301 is mechanically connected to the optical vibration isolation platform 102, e.g., the camera stand 301 may be fixedly connected to the optical vibration isolation platform 102 by welding, threaded connection, etc.

In some embodiments, the camera 302 is mechanically connected to the camera stand 301. For example, the camera 302 may be fixedly connected to the camera stand 301 by welding, threaded connection, etc.

In some embodiments, the camera 302 is used to observe a position of the laser and electrochemical composite deposition before processing or before the experiment and the camera 302 is used to record an electrochemical deposition process. Exemplarily, the camera 302 is a digital camera or a single-lens reflex camera (DSLR camera). An experiment refers to an experiment that tests the laser and electrochemical composite deposition process.

In some embodiments, the 100 also include a light source (e.g., a white light source, etc.). The light source is used for illumination of the camera 302. The light source is detachably connected to the optical vibration isolation platform 101 via an optical tube sleeve. The optical tube sleeve is a structure that provides mounting, positioning, and protection functions for optical components (e.g., a light source, a prism, a mirror, etc.).

In some embodiments of the present disclosure, the images and videos captured by the camera allow users to record a processing or experimental process and to perform subsequent analyses; the camera stand provides a stable mounting platform for the camera to reduce an impact on the quality of the captured images during the composite deposition process.

In some embodiments of the present disclosure, the visualization component (e.g., a camera) enables clear, jitter-free images to be obtained under a high-precision machining condition or an experimental condition, which is particularly important for observing microstructural changes and for electrochemical deposition processes that require a high measurement accuracy. The visualization component may allow the users to monitor activities within the electrolytic cell body in real-time to ensure that the composite deposition process is proceeding as expected, which is conducive to improving the quality and efficiency of the manufacturing of 3D structural components.

FIG. 2 is a main cross-sectional view illustrating an exemplary laser induced electrochemical deposition five-axis additive manufacturing device according to some embodiments of the present disclosure.

In some embodiments, as shown in FIG. 2, the displacement control component 2 includes: a first moving platform 201, a second moving platform 202, a third moving platform 203, a first rotating platform 204, and a second rotating platform 205. The third moving platform 203 is fixed to mounting holes in a side wall of the gantry 102; the first moving platform 201 is fixed to the optical vibration isolation platform 101 through threaded holes on the optical vibration isolation platform 101; the second moving platform 202 is mechanically connected to the first moving platform 201; the second rotating platform 205 is mechanically connected to the second moving platform 204; and the first rotary platform 204 is mechanically connected to the second rotating platform 202.

In some embodiments, the coupling component 5 is fixedly connected to the third moving platform 203 of the displacement control component 2; the electrode component 4 is fixedly connected to the second rotating platform 205 of the displacement control component 2, and the coupling component 5 is disposed above the electrode component 4.

The first moving platform 201 is used to control a partial structure of the electrode component 4 to move in a first direction.

In some embodiments, the first moving platform 201 may include a first bearing platform and a first moving component. The first bearing platform may be used to bear other components or be mechanically connected to other components. The first moving component may drive the first bearing platform in the first direction relative to the optical vibration isolation platform 101.

In some embodiments, the first moving component may include a linear guide, a ball screw, etc., arranged along the first direction (e.g., an X-axis direction). In some embodiments, the first moving component may be fixed to the optical vibration isolation platform 101 through the threaded holes on the optical vibration isolation platform 101.

In some embodiments, the first bearing platform is slidably connected to the first moving component. The first bearing platform may move along the first moving component, namely, along the X-axis direction relative to the optical vibration isolation platform 101. When the first bearing platform moves in the X-axis direction relative to the optical vibration isolation platform 101, a structure connected to or provided on the first bearing platform may be driven to move in the X-axis direction relative to the optical vibration isolation platform 101.

In some embodiments, the first moving platform 201 may control the partial structure of the electrode component 4 and other moving or rotating platforms to move in the X-axis within a certain range. For example, when the first moving platform 201 (e.g., the first bearing platform in the first moving platform 201) moves along the X-axis, it drives other components (including the second moving platform 202, the first rotating platform 204, the second rotating platform 205, and the partial structure of the electrode component 4) fixed on the first moving platform 201 to move synchronously along the X-axis.

The second moving platform 202 is used to control the electrolytic cell body 401 to move in a second direction. In some embodiments, the second moving platform 202 may include a second bearing platform and a second moving component. The second bearing platform may be used to bear or mechanically connect to other components. The second moving component may drive the second bearing platform to move in the second direction relative to the optical vibration isolation platform 101.

In some embodiments, the second moving component may include a linear guide, a ball screw, etc. disposed along the second direction (e.g., a Y-axis direction). In some embodiments, a lower surface of the second moving component may be mechanically connected to an upper surface of the first bearing platform.

According to some embodiments of the present disclosure, the upper surface may be a side surface in a third direction that departs from the main support component 1. In contrast, the lower surface is a side surface in the third direction facing the main support component 1.

In some embodiments, the second bearing platform is slidably connected to the second moving component. The second bearing platform may move along the second moving component, namely, in the Y-axis direction relative to the optical vibration isolation platform 101. When the second bearing platform moves in the Y-axis direction relative to the optical vibration isolation platform 101, a structure connected to or provided on the second bearing platform may be driven to move in the Y-axis direction relative to the optical vibration isolation platform 101.

In some embodiments, the second moving platform 202 may control the partial structure of the electrode component 4 and other moving or rotating platforms, to move along the Y-axis within a range. For example, when the second moving platform 202 (e.g., the second bearing platform in the second moving platform 202) moves along the Y-axis, it drives other components (including the first rotating platform 204, the second rotating platform 205, and the partial structure of the electrode component 4) on the second moving platform 202 to move synchronously along the Y-axis.

The third moving platform 203 is used to control the coupling component 5 to move in the third direction. In some embodiments, the third moving platform 203 may include a third bearing platform and a third moving component. The third bearing platform may be used to carry other components (e.g., the coupling component 5) or to mechanically connect to other components. The third moving component may drive the third bearing platform to move in the third direction relative to the optical vibration isolation platform 101.

In some embodiments, the third moving component may include a linear guide, a ball screw, etc., disposed along the third direction (e.g., a Z-axis direction). In some embodiments, the third moving component may be fixed to the mounting holes in a side wall of the gantry 102 by welding, threaded connection, etc. In some embodiments, the mounting holes on the side wall may be disposed on a beam of the gantry 102.

In some embodiments, the third bearing platform is slidably connected to the third moving component. The third bearing platform may move along the third moving component, namely, in the Z-axis direction relative to the optical vibration isolation platform 101. When the third bearing platform moves in the Z-axis direction relative to the optical vibration isolation platform 101, a structure connected to the third bearing platform or provided on the third bearing platform may be driven to move in the Z-axis direction relative to the optical vibration isolation platform 101.

In some embodiments, the third moving platform 203 may control the coupling component 5 to move along the Z-axis within a range. For example, the third moving platform 203 may be fixedly connected to the coupling component 5. When the third moving platform 203 (e.g., the third bearing platform in the third moving platform 203) moves along the Z-axis, it drives the coupling component 5 that is fixedly connected to the third moving platform 203 to move synchronously along the Z-axis, thereby realizing a positioning of the coupling component 5 in the Z-axis direction.

The first rotating platform 204 is used to control the partial structure of the electrode component 4 to rotate about the first direction. For example, the first rotating platform 204 may include a rotating table and a drive mechanism, etc., and the drive mechanism may include an electric motor or other power sources, etc., to drive the rotating table to rotate.

In some embodiments, the first rotating platform 204 is mechanically connected to the second moving platform 202. For example, the first rotating platform 204 is mechanically connected to a top surface of the second moving platform 202. Exemplarily, the first rotating platform 204 is disposed on the second moving platform 202, and a lower surface of the first rotating platform 204 is connected to an upper surface of the second moving platform 202 through a moving component (e.g., a bearing, etc.).

In some embodiments, the first rotating platform 204 may control the partial structure of the electrode component 4 to rotate about the X-axis within a range (e.g.,) 180°. For example, when the first rotating platform 204 rotates about the X-axis, it drives the second rotating platform 205 connected to the first rotating platform 204 to rotate about the X-axis, thereby driving the partial structure of the electrode component 4 fixedly connected to the second rotating platform 205 to move synchronously about the X-axis, and further adjusting an angle of the partial structure of the electrode component 4 relative to the optical vibration isolation platform 101.

The second rotating platform 205 is used to control the partial structure of the electrode component 4 to rotate about the third direction. For example, the second rotating platform 205 may include a rotating table and a drive mechanism, etc.

In some embodiments, the second rotating platform 205 is mechanically connected to the first rotating platform 204. Exemplarily, the second rotating platform 205 may be disposed on the first rotating platform 204, and a lower surface of the second rotating platform 205 is connected to an upper surface of the first rotating platform 204 through a moving component (e.g., a bearing, etc.). The partial structure of the electrode component 4 is fixedly connected to a top surface of the second rotating platform 205.

In some embodiments, the second rotating platform 205 may control the partial structure of the electrode component 4 to rotate about the Z-axis within a range. Exemplarily, when the second rotating platform 205 rotates around the Z-axis, it drives the partial structure of the electrode component 4 fixedly connected to the second rotating platform 205 to rotate about the Z-axis, and further adjusting an angle of the partial structure of the electrode component 4 relative to the Z-axis.

In some embodiments, the displacement control component 2 may drive a plurality of other components (e.g., the partial structures of the electrode component 4 and the second moving platform 202, the first rotating platform 204, the second rotating platform 205) fixed thereto to move synchronously along the X-axis when controlling the first moving platform 201 (e.g., the first bearing platform in the first moving platform 201) to move along the X-axis; drive a plurality of other components (e.g., the partial structures of the electrode component 4 and the first rotating platform 204, the second rotating platform 205) fixed thereto to move synchronously along the Y-axis when controlling the second moving platform 202 (e.g., the second bearing platform in the second moving platform 202) to move along the Y-axis; drive the second rotating platform 205 mechanically connected thereto and the partial structure of the electrode component 4 to rotate about the X-axis when controlling the first rotating platform 204 rotate about the X-axis; and drive the partial structure of the electrode component 4 fixedly connected thereto to rotate about the Z-axis when controlling the second rotating platform 205 to rotate about the Z-axis.

According to some embodiments of the present disclosure, by using a plurality of independent moving platforms (the first moving platform, the second moving platform, the third moving platform) and rotating platforms (the first rotating platform, the second rotating platform), each portion may be independently adjusted and move, thereby increasing flexibility and scalability of the system. In this way, the users may adjust the position and direction of each platform according to specific needs, thereby realizing a multi-dimensional complex motion control.

In some embodiments, as shown in FIG. 1, the electrode component 4 includes an electrolytic cell body 401, an electrochemical workstation 402, and a signal connection line 403. The electrolytic cell body 401 is mechanically connected to the second rotating platform 205; the electrochemical workstation 402 is fixed to the optical vibration isolation platform 101; and the electrochemical workstation 402 is in a three-electrode connection to the electrolytic cell body 401 through the signal connection line 403.

The electrolytic cell body 401 is a device for performing an electrochemical reaction. For example, the electrolytic cell body 401 may include a plurality of electrode terminals and an electrolyte reservoir that holds electrolytes. A count of electrode terminals of the electrolytic cell body 401 is the same as a count of electrodes in the electrochemical workstation 402.

In some embodiments, the electrolytic cell body 401 may include a working electrode terminal, a reference electrode terminal, and a counter electrode terminal connected to the electrolyte reservoir. In some embodiments, a component to be processed is fixed in the electrolyte reservoir by the working electrode terminal while an electrochemical reaction formula is performed.

In some embodiments, the working electrode terminal may be a glassy carbon terminal, the counter electrode terminal may be an Ag/AgCl, platinum wire terminal, and the reference electrode terminal may be a platinum sheet, Ag/AgCl terminal.

In some embodiments, the electrolytic cell body 401 may be fixedly connected to the second rotating platform 205, and the displacement control component 2 may enable the electrolytic cell body 401 to adjust an angle or change a position within a certain range.

In some embodiments, the displacement control component 2 may drive a plurality of other components (e.g., the electrolytic cell body 401, the second mobile platform 202, the first rotating platform 204, the second rotating platform 205) fixed thereto to move synchronously along the X-axis when controlling the first moving platform 201 (e.g., the first bearing platform in the first moving platform 201) to move along the X-axis; and drive a plurality of other components (e.g., the electrolytic cell body 401, the second mobile platform 202, the first rotating platform 204, and the second rotating platform 205) fixed thereto to move synchronously along the Y-axis when controlling the second moving platform 202 (e.g., the second bearing platform in the second moving platform 202) to move along the Y-axis; drive the second rotating platform 205 mechanically connected to the displacement control component 2 and the electrolytic cell body 401 to rotate about the X-axis when controlling the first rotating platform 204 to rotate about the X-axis; and drive the electrolytic cell body 401 fixedly connected to the displacement control component 2 to rotate about the Z-axis when controlling the second rotating platform 205 to rotate about the Z-axis.

In some embodiments, the electrolyte reservoir is also provided with gas outlet holes, which are provided on a housing of the electrolyte reservoir to ensure that the gas is discharged uniformly. A count of gas outlet holes may be determined based on actual application requirements.

The electrochemical workstation 402 is a system for controlling or monitoring electrochemical parameters in an electrochemical reaction. For example, the electrochemical workstation 402 may record a potential, a current, a capacitance, etc., during the electrochemical reaction.

In some embodiments, the electrochemical workstation 402 may include a power supply and a signal generator, etc., and the signal generator is electrically connected to the power supply. The signal generator is used to observe a pulse frequency and waveform provided by the power supply, which facilitates the user in adjusting the power supply to obtain a desired pulse frequency and waveform.

In some embodiments, the electrochemical workstation 402 includes three electrodes, namely a working electrode, a reference electrode, and a counter electrode.

In some embodiments, the electrochemical workstation 402 is fixed to the optical vibration isolation platform 101. For example, the electrochemical workstation 402 may be fixed to the optical vibration isolation platform 101 by welding, threaded connection, etc.

The signal connection line 403 connects electrode terminals of the electrochemical workstation 402 to cables of each electrode in the electrolytic cell body 401. For example, the signal connection line 403 may be an electrochemical cable with a bayonet nut connector (BNC).

In some embodiments, the electrochemical workstation 402 is in a three-electrode connection to the electrolytic cell body 401 through the signal connection line 403. Exemplarily, the signal connection line 403 consists of three signal wires. One end of each of the three signal wires connects to the working electrode terminal, the reference electrode terminal, and the counter electrode terminal, respectively. The other end of the three signal wires connects to a working electrode interface, a reference electrode interface, and a counter electrode interface on the electrochemical workstation 402, respectively.

In some embodiments of the present disclosure, by mechanically connecting the electrolytic cell body with the first moving platform, the second moving platform, and the third moving platform, as well as the first rotating platform and the second rotating platform, a precise positioning and a multi-angle operation of the electrolytic cell body may be realized, which is conducive to a precise control of the position of the electrochemical reaction. By fixing the electrochemical workstation on the optical vibration isolation platform, effects of external vibrations on the electrochemical processing may be reduced, thereby improving the stability and repeatability of the processing. The reference electrode provides a stable potential reference, while the working electrode carries out an actual electrochemical reaction, a more precise potential control may be provided by the three-electrode connection.

FIG. 3 is a side cross-sectional view illustrating an exemplary laser induced electrochemical deposition five-axis additive manufacturing device according to some embodiments of the present disclosure.

In some embodiments, as shown in FIG. 3, the coupling component 5 includes: a coupling cavity fixture 507, an optical coupling cavity 505, a first focusing lens 504, an electrolyte reservoir 503, and a probe 501 disposed in sequence in a third direction. The optical coupling cavity 505, the first focusing lens 504, and the electrolyte reservoir 503 are optically connected in sequence. The electrolyte reservoir 503 is fixedly connected to the probe 501; one end of the coupling cavity fixture 507 clamps the electrolyte reservoir 503, and the other end of the coupling cavity fixture 507 is movably connected to the third moving platform 203 to enable the coupling component 5 to move in the third direction.

In some embodiments, the optical coupling cavity 505, the first focusing lens 504, the electrolyte reservoir 503, and the probe 501 may be disposed in a top-to-bottom sequence above the electrolyte reservoir along the third direction.

An optical path connection refers to a connection relationship in an optical system in which various optical elements (e.g., the optical coupling cavity 505, the first focusing lens 504, etc.) are arranged in a sequence of light propagation to ensure that the light may be continuously and unobstructedly transmitted from one element to the next element, thereby completing a specific optical function (e.g., focusing, etc.). The top-to-bottom sequence refers to a sequence along the third direction, down from the highest position away from the main support component 2.

The coupling cavity fixture 507 is a mechanical structure for fixing and positioning. For example, the coupling cavity fixture 507 includes a clamping device, etc.

In some embodiments, one end of the coupling cavity fixture 507 may be used to clamp the electrolyte reservoir 503.

In some embodiments, the other end of the coupling cavity fixture 507 is fixedly connected to the third moving platform 203. Exemplarily, the coupling cavity fixture 507 may be fixed to the third moving platform 203 by a locking screw 506. When the third moving platform 203 is moved in the third direction, the coupling cavity fixture 507 may move in the third direction. As one end of the coupling cavity fixture 507 clamps the electrolyte reservoir 503, and the electrolyte reservoir 503 is connected with the optical coupling cavity 505, the first focusing lens 504 above, and connected with the probe 501 below, the coupling cavity fixture 507 may drive the optical coupling cavity 505, the first focusing lens 504, the electrolyte reservoir 503, and the probe 501 to move in the third direction when the coupling cavity fixture 507 is moving in the third direction.

The optical coupling cavity 505 is an optical element for guiding and controlling a path of a laser beam. In some embodiments, the optical coupling cavity 505 may include a mirror, a lens, or other optical devices to ensure that the laser beam is focused and directed.

FIG. 4 is a schematic diagram illustrating an exemplary optical path connection within an optical coupling cavity according to some embodiments of the present disclosure.

In some embodiments, as shown in FIG. 4, the optical coupling cavity 505 includes a laser 505-1, a beam extension system 505-2, a diaphragm 505-3, and a second focusing lens 505-4 connected optically in sequence in a third direction.

The laser 505-1 is a device that generates a laser beam. For example, the laser 505-1 may be a solid laser, a gas laser, a semiconductor laser, or a fiber laser, etc.

The beam extension system 505-2 is a device for extending a diameter of the laser beam. For example, the beam extension system 505-2 may include a lens array or other optical elements for extending or shaping the laser beam. The beam extension system 505-2 helps to minimize a beam divergence and ensures that a uniformity of a spot size and a consistency of an energy distribution are maintained over a longer optical path transmission.

The diaphragm 505-3 is an adjustable light hole.

In some embodiments, the diaphragm 505-3 is disposed in a beam path to limit a cross-sectional size of the laser beam, remove an edge stray light, and improve beam quality. A uniformity and a focusing effect of the beam may be further optimized by adjusting a size of the diaphragm 505-3. The second focusing lens 505-4 is used to refocus a passing laser beam to suit specific deposition or processing needs. Precise control of a laser focus may be achieved by precisely adjusting a position and a focal length of the second focusing lens 505-4.

In some embodiments, the beam path is a top-to-bottom transmission path along the third direction. Correspondingly, the laser 505-1, the beam extension system 505-2, the diaphragm 505-3, and the second focusing lens 505-4 are fixed to the optical coupling cavity 505 in a vertical direction from top to bottom by using an optical strut or an optical connecting rod.

In some embodiments of the present disclosure, by a precise optical path design and control, a loss of optical energy may be minimized to ensure efficient transmission of the laser energy to a deposition region; components may be sequentially arranged along the optical path, which facilitates parameter adjustments and system maintenance by technicians. For example, adjusting the diaphragm size may be adjusted, and the focusing lens may be replaced individually, without affecting other components, thereby improving a flexibility and an operability of the system.

The first focusing lens 504 is used to focus the laser beam to a smaller region and to increase a localized energy density. The first focusing lens 504 may accurately control a process of heating and melting a material to promote the formation of a fine structure of a deposited material.

It should be noted that the second focusing lens 505-4 is a primary focusing lens for refocusing the laser after beam extension, so as to further control a beam size and an energy distribution. The first focusing lens 504 is a secondary focusing lens for finer focusing of the laser beam that has passed through the first focusing lens, so as to achieve a desired focal spot size and an intensity distribution.

The electrolyte reservoir 503 is a container for storing electrolyte for an electrochemical deposition.

In some embodiments, an liquid outlet is provided at a bottom of the electrolyte reservoir 503. The liquid outlet is used to discharge or export the electrolyte inside the electrolyte reservoir 503. The bottom of the electrolyte reservoir 503 refers to an end proximate the electrolytic cell body 401.

In some embodiments, an electrolyte inlet 502 is disposed on a side wall of the electrolyte reservoir 503, and the electrolyte may be added to the electrolyte reservoir 503 from the electrolyte inlet 502 by a pressure pump.

The probe 501 is used to guide the electrolyte from the electrolyte reservoir 503 into the electrolyte reservoir. In some embodiments, the liquid outlet of the probe 501 may be designed to be flat, tapered, or in other special shapes to adapt to different deposition surfaces and improve deposition efficiency.

In some embodiments, the electrolyte reservoir 503 is fixedly connected to the probe 501. Exemplarily, the probe 501 is connected to an outlet underneath the electrolyte reservoir 503 such that the electrolyte is extruded from the outlet of the probe 501.

In some embodiments of the present disclosure, the optical coupling cavity, the first focusing lens, and the second focusing lens together form a fine optical path system to ensure that the laser energy is efficiently and accurately transmitted to the processing region. The optical path system reduces energy loss, and enhances deposition efficiency and quality. A combination of the electrolyte reservoir and the probe realizes a precise control and delivery of the electrolyte to ensure the continuity and uniformity of an electrochemical reaction. A direct action of the probe on the deposition region contributes to a formation of a high-quality deposition layer, especially when precise control of the distribution of the deposited material is required.

In some embodiments, the additive manufacturing device 100 may also include a controller (not shown in FIGS. 1-4).

The controller refers to a system with a computing capability, such as a computer, an industrial controller, a computing cloud platform, etc. In some embodiments, the control module may include one or more sub-processors. For example, a central processing unit (CPU), a graphics processing unit (GPU), or any combination thereof.

In some embodiments, the controller may be communicatively connected to the displacement control component 2, the optical coupling cavity 505, etc. to obtain data and/or information. The controller may execute program instructions based on these data, information, and/or processing results to perform one or more functions described in the embodiments of the present disclosure.

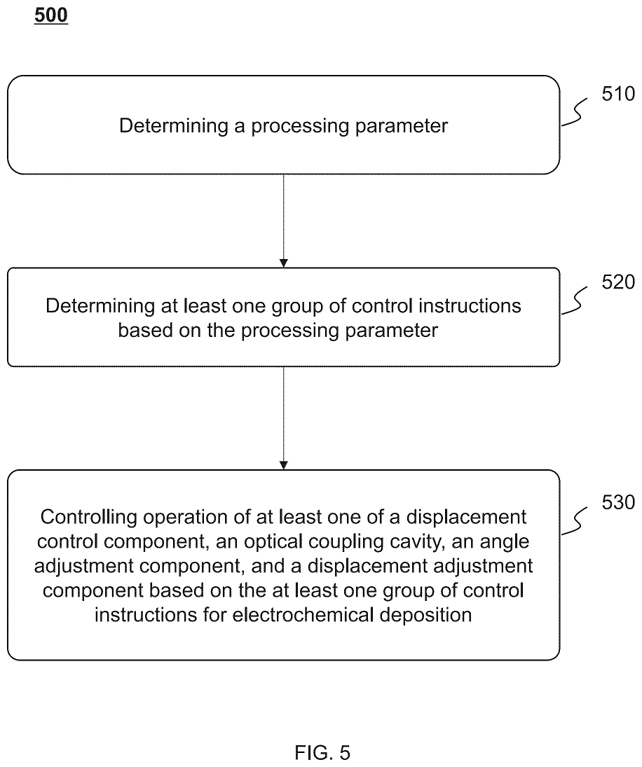

In some embodiments, the displacement control component 2 further includes a driving motor (not shown in FIGS. 1-4). The controller may be configured to: send a displacement instruction to control the displacement control component 2 to drive at least one of the first moving platform, the second moving platform, and the third moving platform, and/or at least one of the first rotating platform and the second rotating platform to perform a displacement based on the driving motor. For more details about the driving motor, please refer to the relevant descriptions in FIG. 5.

In some embodiments of the present disclosure, the driving motor is able to control a coupling component and the electrolytic cell body to achieve a complex motion and path planning, thereby improving the efficiency of the laser and an electrochemical deposition process.

In some embodiments, the additive manufacturing device 100 further includes a level sensor component (not shown in FIGS. 1-4). The level sensor component is mechanically connected to the electrolytic cell body 401 and is configured to monitor an inclination of the electrolytic cell body 401.

The level sensor component may be used as an instrument for measuring and monitoring the inclination of the electrolytic cell body 401 relative to a plane (e.g., a top surface of the optical vibration isolation platform 101). For example, the level sensor component includes, but is not limited to, a bubble level, an electronic level, etc.

In some embodiments, the level sensor component may be fixedly mounted at a geometric center or a symmetrical axis position of the electrolytic cell body 401.

In some embodiments, the level sensor component is communicatively connected to the controller. The level sensor component may send the measured inclination of the electrolytic cell body 401 in real-time or periodically to the controller.

In some embodiments, the electrolytic cell body 401 is a removable component. Before processing, the controller may detect whether the electrolytic cell body 401 is mounted horizontally based on the level sensor component. The processing refers to a process of performing a material deposition within the electrolytic cell body 401 by utilizing laser induced electrochemical deposition techniques.

In some embodiments, during the processing, the controller may determine in real-time whether the inclination meets a warning requirement; and send a warning when the inclination meets the warning requirement. The warning requirement includes that the inclination is greater than an inclination threshold. The inclination threshold may be a system default, a system preset, etc. Exemplarily, the inclination threshold may be zero.

The warning refers to information related to a possible safety hazard in the additive manufacturing device 100. For example, the warning may include the inclination exceeding the inclination threshold, an electrolyte leakage, an electrical leakage, etc. The warning may be communicated to a user via sound, a visual signal, a text message, email, or a mobile app notification.

In some embodiments, the additive manufacturing device 100 further includes a display device (e.g., a display) for displaying the inclination. In some embodiments, the additive manufacturing device 100 may send the warning via the display device.

In some embodiments of the present disclosure, the electrochemical process of precisely controlling an electrolyte surface or an electrode position is facilitated by ensuring that the electrolyte reservoir remains horizontal.

In some embodiments, the coupling component 5 further includes an angle adjustment component (not shown in FIGS. 1-4). The angle adjustment component is mechanically connected to the optical coupling cavity 505 and communicatively connected to the controller.

The angle adjustment component is used to adjust an irradiation angle of the optical coupling cavity 505. For example, the angle adjustment component may include an acousto-optic deflector, an optical adjustment frame, etc.

In some embodiments, the angle adjustment component is mechanically connected to the optical coupling cavity 505. For example, the angle adjustment component is fixedly connected to an optical element (e.g., a reflector or a prism) in the optical coupling cavity 505.

In some embodiments, the angle adjustment component is communicatively connected to the controller to receive the angle adjustment instruction from the controller. The angle adjustment component may adjust the angle of the optical element (e.g., the reflector or the prism) in the optical coupling cavity 505 to adjust the irradiation angle based on the angle adjustment instruction. For more details about adjusting the irradiation angle, please refer to the relevant description of FIG. 5.

In some embodiments of the present disclosure, by accurately controlling the angle adjustment component, a fine adjustment of an angle of the laser beam may be realized, which is conducive to a high-precision alignment or focusing. The communication connection with the controller allows an angle adjustment to be performed automatically, thereby reducing the need for human intervention, improving work efficiency, and reducing errors caused by humans.

In some embodiments, the optical coupling cavity 505 is further configured with a displacement adjustment component (not shown in FIGS. 1-4). The displacement adjustment component is mechanically connected to the optical coupling cavity 505 and communicatively connected to the controller.

The displacement adjustment component is used to adjust the position of the optical coupling cavity 505 in the third direction. For example, the displacement adjustment component may include a slide (e.g., a precision slide, etc.) disposed along the third direction.

In some embodiments, the displacement adjustment component is mechanically connected to the optical coupling cavity 505. For example, the optical coupling cavity 505 is slidingly connected to the slide.

In some embodiments, the displacement adjustment component is communicatively connected to the controller to receive an instruction from the controller. The displacement adjustment component may adjust the position of the optical coupling cavity 505 in the third direction based on the instruction from the controller. For more details about adjusting the position of the optical coupling cavity 505 in the third direction, please refer to the relevant descriptions of FIG. 5.

In some embodiments of the present disclosure, a change in the irradiation angle of the optical system during operation results in an optical path offset. The controller monitors the optical path offset and instructs the displacement adjustment component to perform a real-time adjustment, thereby effectively compensating for deviations caused by the optical path offset, optimizing a distribution of the laser energy, and avoiding a decline of processing surface quality due to a focal point deviation.

The present disclosure also provides a method for laser induced electrochemical deposition. The method includes: connecting a working electrode, a reference electrode, and a counter electrode of an electrochemical workstation to a working electrode terminal, a reference electrode terminal, and a counter electrode terminal of an electrolytic cell body correspondingly via signal connection lines for electrochemical deposition.

The present disclosure also provides a controlling method for laser induced electrochemical deposition. The method is performed by a controller, and the method includes: determining a processing parameter; determining at least one group of control instructions based on the processing parameter; and controlling the operation of at least one of a displacement control component, an optical coupling cavity, an angle adjustment component, and a displacement adjustment component based on the at least one group of control instructions for electrochemical deposition. For more details about this embodiment, please refer to the relevant description of FIG. 5.

In some embodiments, the additive manufacturing device may also include a store module used to store data, instructions, or any other information. For example, the storage module may store processing parameters, etc. In some embodiments, the storage module may include a random access memory (RAM), a read-only memory (ROM), a mass memory, a removable memory, a volatile read/write memory, etc., or any combination thereof. In some embodiments, the storage module may be integrated or included in one or more other components (e.g., a controller, a user terminal, etc.) of the additive manufacturing system 100.

FIG. 5 is a flowchart illustrating an exemplary controlling method for a laser induced electrochemical deposition according to some embodiments of the present disclosure.

In some embodiments, a process 500 may be implemented based on a controller for a laser induced electrochemical deposition five-axis additive manufacturing device. As shown in FIG. 5, the process 500 includes the following steps.

Step 510, determining a processing parameter.

The processing parameter refers to a set of parameters that guide and control the entire laser induced electrochemical deposition process.

In some embodiments, the processing parameter includes at least one of a moving route, at least one processing position and corresponding position information, a laser processing parameter, or any combination thereof.

The moving route refers to a trajectory of a probe or an electrolytic cell body during the laser induced electrochemical deposition.

In some embodiments, the moving route may include a series of pre-planned 3D coordinate points. The controller may establish a 3D model of a processing region based on a computer-aided design software (e.g., a CAD). Each 3D coordinate point represents a position of the probe or the electrolytic cell body in the 3D model. The processing region at least includes a component to be processed and a route coverage region. The component to be processed is a component that is required to realize a complex 3D structure, a special material deposition, or a surface treatment. In some embodiments, the component to be processed may be fixed in an electrolyte reservoir. The component to be processed may be connected to a working electrode via a working electrode terminal. The route coverage region refers to a region that needs to be covered by a movement of the probe or electrolytic cell body on a surface of the component to be processed.

In some embodiments, one or more 3D coordinate points in the moving route correspond to the at least one processing position.

The processing position refers to an exact position in the component to be processed for each electrochemical deposition or laser action.

Position information refers to position information of the processing position in the 3D model. For example, the position information includes the 3D coordinate points corresponding to the processing position.

In some embodiments, the processing position may be preset individual reference position on the component to be processed. In some embodiments, the processing position may include a sequence of different reference positions in a chronological order.

The laser processing parameter refers to a parameter used by a coupling component in the laser induced electrochemical deposition process. The laser processing parameter includes an initial spot position, an initial angle, etc.

The spot position refers to a position of a laser spot on the component to be processed.

The initial spot position refers to a spot position determined before the process. In some embodiments, the initial spot position may be a position where a center of a spot coincides with a center of a probe opening.

An irradiation angle refers to an angle of incidence of the laser beam in the optical coupling cavity relative to the processing position.

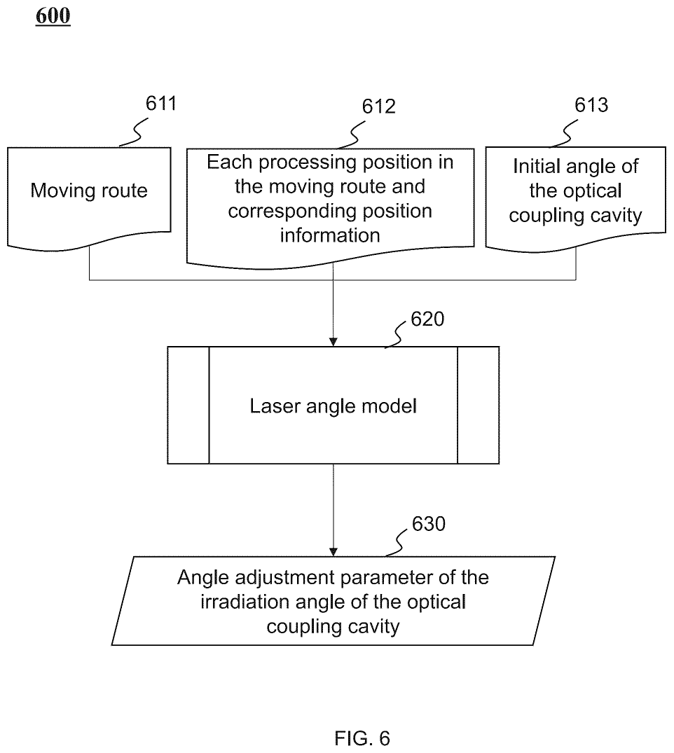

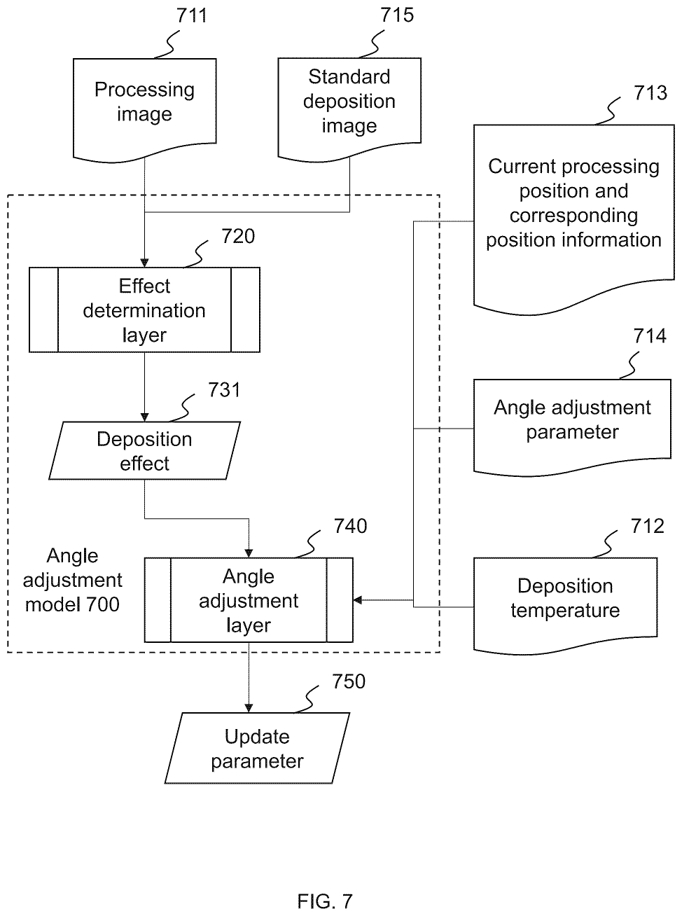

The initial refers to an irradiation angle for each processing position determined before the processing. For example, the initial angle may be a sequence including an initial irradiation angle for each processing position. During the processing process, the angle of incidence of the laser beam in the optical coupling cavity relative to one processing position may be adjusted. For details, please refer to relevant descriptions in FIG. 6 and FIG. 7.

In some embodiments, the processing parameter further includes an electrochemical deposition parameter.

The electrochemical deposition parameter refers to a parameter related to an electrolyte solution or an applied electric field. For example, the electrochemical deposition parameter includes a composition and a ratio of the electrolyte, a current density, a potential, a deposition time, etc.

In some embodiments, the controller may determine the processing parameter in various ways. For example, the controller may determine the processing parameter through a manual input, a storage device, calling a data interface, etc. For another example, the controller may determine the processing parameter based on prior knowledge or historical data. For another example, the controller may determine the moving route through a route planning algorithm (e.g., a Dijkstra's algorithm, an A* algorithm, etc.).

Step 520, determining at least one group of control instructions based on the processing parameter.

The control instructions refer to instructions used to control an operation of one or more components in the additive manufacturing device.

In some embodiments, the control instructions may be instructions for controlling an operation of the displacement control component, the optical coupling cavity, the angle adjustment component, the displacement adjustment component, etc. In some embodiments, there may be one or more instructions. For example, a displacement instruction corresponding to the displacement control component, a focus adjustment instruction corresponding to the optical coupling cavity, and an angle adjustment instruction corresponding to the angle adjustment component. For more details about the displacement instruction, the focus adjustment instruction, and the angle adjustment instruction, please refer to the relevant descriptions in FIG. 5.

In some embodiments, the controller may determine the corresponding control instructions based on the processing parameter. For example, the controller may determine historical control instructions as current control instructions based on the same or similar processing parameters at the same time in history. For another example, the controller may preset different moving routes, the processing positions in different moving routes, and corresponding position information, and a correspondence between the laser processing parameter and the control instructions, so as to determine the current control instructions by table-checking.

In some embodiments, the displacement control component further includes a driving motor. The controller may issue the displacement instruction to control the displacement control component to drive at least one moving platform and/or at least one of the rotating platform to perform a displacement based on the driving motor.

Types of the driving motor include, but are not limited to, a servo motor, a stepper motor, or a direct driving motor.

In some embodiments, the moving platforms include at least one of the first moving platform 201, the second moving platform 202, and the third moving platform 203. In some embodiments, the rotating platforms include at least one of the first rotating platform 204 and the second rotating platform 205.

In some embodiments, each of the first moving platform 201, the second moving platform 202, the third moving platform 203, the first rotating platform 204, and the second rotating platform 205 may correspond to one driving motor.

In some embodiments, each driving motor is communicatively connected to the controller to receive the displacement instruction from the controller. Each driving motor may drive the corresponding moving platform to move based on its displacement instruction.

The displacement instruction refers to an instruction that controls the operation of the displacement control component. In some embodiments, the displacement instruction may control the displacement control component to move based on a moving parameter.

The moving parameter is a parameter used by the moving platforms or the rotating platforms when performing a movement or a rotation. In some embodiments, the moving parameter includes the moving platform, a moving distance, a moving direction, a moving speed, and/or a rotating angle, a rotating direction, a rotating speed of the rotating platform, etc. of the movement.

In some embodiments, the controller may determine a current position and a next position of the probe or the electrolytic cell body in the moving route based on the moving route; determine the moving parameter based on the current position and the next position of the probe or the electrolytic cell body; and generate the corresponding displacement instruction based on the moving parameter, thereby controlling the at least one moving platform and/or the at least one rotating platform to move the probe or the electrolytic cell body from the current position to the next position via the driving motor.

In some embodiments, the controller may calculate the moving distance, the moving direction, and the moving speed of the moving platform, and/or the rotating angle, the rotating direction, and the rotating speed of the rotating platform based on the current position and the next position, so as to determine the moving parameter.

The next position refers to a position in the moving route that the probe or electrolytic cell body is about to move to. The next position may be a position in the moving route that is after the current position.

In some embodiments of the present disclosure, by means of the displacement instruction, the controller may realize a high-precision positioning and motion control of the moving platforms and the rotating platforms, which is conducive to reducing a manual intervention, improving a productivity and consistency, and helps to reduce errors and production costs in mass production and continuous machining processes.

In some embodiments, the controller may send the angle adjustment instruction to control the angle adjustment component to adjust the irradiation angle of the optical coupling cavity. For more detailed contents of the angle adjustment component, please refer to the relevant description of FIG. 5.

The angle adjustment instruction refers to an instruction that controls the angle adjustment component to adjust the irradiation angle.

In some embodiments, the angle adjustment instruction may control the angle adjustment component to adjust the irradiation angle of the optical coupling cavity based on an angle adjustment parameter.

The angle adjustment parameter refers to a parameter used by the angle adjustment component in adjusting the irradiation angle of the optical coupling cavity. In some embodiments, the angle adjustment parameter may include an angle adjustment amount, an adjustment direction, etc. The adjustment direction may include adjusting up, adjusting down, etc.

The angle adjustment amount refers to an amount of change in the irradiation angle of the optical coupling cavity before and after adjustment.

In some embodiments, the controller may determine the angle adjustment parameter in various ways. For example, the controller may determine the moving route, the processing position, and a correspondence between different combinations of corresponding position information and different angle adjustment parameters based on the historical data, and determine the angle adjustment parameter by table-checking.

In some embodiments, before the processing, the controller may adjust an initial angle and determine the angle adjustment parameter in various ways, such as by manual analysis, theoretical calculation, etc. In some embodiments, during the processing, the controller may determine the angle adjustment parameter based on an actual situation during the processing. Exemplarily, the controller determines that a light spot is blocked based on a weakening of a light spot intensity at the current processing position, adjusts the irradiation angle corresponding to the current processing position, and determines the angle adjustment parameter.

It may be noted that when the component to be processed involves a 3D complex micro-nano structured component, it may be ensured by the irradiation angle that the laser spot is not blocked (e.g., blocked by a complex 3D shape of the component to be processed or by other components of the additive manufacturing device) when moved to the corresponding processing position; at the same time, it may be ensured by the irradiation angle that the laser spot meets processing requirements when the coupling component moves in a vertical direction.

In some embodiments, the controller may send a corresponding angle adjustment instruction to control the angle adjustment component to adjust the irradiation angle of the optical coupling cavity based on the angle adjustment parameter.

In some embodiments, the controller may predict the angle adjustment parameter for the irradiation angle of the optical coupling cavity based on a laser angle model; the controller may control the angle adjustment component to adjust the irradiation angle of the optical coupling cavity before reaching a target processing position based on the angle adjustment parameter. For more contents about the target processing position and the embodiment, please refer to the relevant description of FIG. 6.

In some embodiments, the controller may further control the angle adjustment component to adjust the irradiation angle of the optical coupling cavity during the processing based on a deposition effect and a deposition temperature. For more details about this embodiment, please refer to the relevant descriptions of FIG. 7.

In some embodiments of the present disclosure, by precisely adjusting the irradiation angle, it is possible to ensure that laser energy is highly concentrated on the processing position, so as to improve processing accuracy; by determining the angle adjustment instruction, the laser angle may be dynamically adjusted according to different operational requirements or environmental changes, thereby improving flexibility and adaptability of the device. For example, in a process of the laser processing, automatically adjusting the laser angle according to the changes in a shape or a position of a workpiece may ensure a consistency of processing quality.

In some embodiments, during the processing, the controller may issue the focus adjustment instruction to control the optical coupling cavity to adjust a laser defocus amount in response to an occurrence of a change in the irradiation angle of the optical coupling cavity.

The laser defocus amount refers to a perpendicular distance between a laser focal point and the processing position.

The focus adjustment instruction refers to an instruction that controls the optical coupling cavity to adjust a focal position of the laser beam.

In some embodiments, the focus adjustment instruction may control the optical coupling cavity to adjust the laser defocus amount based on a focus adjustment parameter.

The focus adjustment parameter refers to a parameter related to the adjustment of the laser defocus amount. For example, the focus adjustment parameter includes a focus adjustment amount and a direction of adjustment. The focus adjustment amount is an amount of change in the laser defocus amount before and after adjustment. The direction of adjustment includes adjusting up, adjusting down, etc.

In some embodiments, the controller may determine a focusing parameter in various ways. For example, the controller may determine the displacement of the coupling component in a third direction and the correspondence of different combinations of the angle adjustment parameter and different focus adjustment parameters based on the historical data and determine the focus adjustment parameter of the current processing position based on table-checking.

In some embodiments, when the irradiation angle of a certain processing position needs to be changed, the controller may send the angle adjustment instruction, and control the angle adjustment component to adjust the irradiation angle of the optical coupling cavity; in response to a change in the irradiation angle, the controller may send a corresponding focus adjustment instruction based on the focus adjustment parameter to control the optical coupling cavity to adjust the laser defocus amount.

According to some embodiments of the present disclosure, by reasonably controlling the laser defocus amount, the laser energy may be more effectively concentrated in the region to be processed, thereby reducing an unnecessary energy loss, and improving energy efficiency. After adjusting the laser irradiation angle, the processing requirements are met while the laser power per unit region is not too high, so as to avoid damaging the component to be processed.

In some embodiments, the controller may determine the displacement of the optical coupling cavity in the third direction based on the displacement of the coupling component in the third direction, and the angle adjustment parameter through a preset algorithm; control the optical coupling cavity to adjust the laser defocus amount based on the displacement of the optical coupling cavity in the third direction.

The displacement of the coupling component in the third direction (hereinafter referred to as a first displacement) is a moving distance of the coupling component corresponding to a certain processing position.

In some embodiments, the controller may determine the first displacement based on the moving route of the third moving platform.

The displacement of the optical coupling cavity in the third direction (hereinafter referred to as a second displacement) refers to a displacement in the third direction that needs to be generated by the optical coupling cavity as the position of the coupling component in the third direction changes with the movement of the third moving platform.

It should be noted that when the probe is moving at a certain processing position, the position of the coupling component in the third direction changes accordingly, and the position of the corresponding optical coupling cavity in the third direction needs to be changed in an opposite direction to resist an effect of the change on the laser defocus amount.

The preset algorithm refers to an algorithm that determines the displacement of the optical coupling cavity in the third direction. The preset algorithm may be a preset formula or a computer rule, etc.

In some embodiments, the preset algorithm includes: determining the second displacement by table-checking. For example, a correspondence between different second displacements and different combinations of the first displacement and the irradiation offset may be determined based on the historical data, and the corresponding second displacement may be determined based on a current first displacement by table-checking.

In some embodiments, the preset algorithm includes determining the second displacement based on a sum value of the first displacement and the irradiation offset. For example, the second displacement is negatively correlated with the above sum value, and the greater the sum value, the smaller the second displacement.

Exemplarily, the second displacement is equal to an opposite count of the sum value of the first displacement and the irradiation offset.

The irradiation offset refers to a transverse or longitudinal deviation distance relative to a reference position from the position where a focal point or a center of the laser beam is located after the irradiation angle adjustment. The reference position may be a position where the focal point or the center of the laser beam is located before the irradiation angle adjustment.

In some embodiments, the irradiation offset may be determined based on the angle adjustment parameter. For example, the controller may determine a correspondence between different adjusted irradiation angles and the corresponding irradiation offsets based on the historical data, and determine a current irradiation offset by table-checking. The adjusted irradiation angle refers to a value obtained after the irradiation angle is adjusted based on the angle adjustment parameter.

In some embodiments, the controller may determine the focus adjustment parameter based on the second displacement and send a corresponding focus adjustment instruction to control the displacement adjustment component to adjust the position of the optical coupling cavity in the third direction and thus control the optical coupling cavity to adjust the laser defocus amount. For example, an absolute value of the second displacement is taken as the displacement of the optical coupling cavity arranged in the third direction in the focus adjustment parameter. A direction of adjustment in the focus adjustment parameter is opposite to a direction of the second displacement.

In some embodiments of the present disclosure, by accurately measuring the displacement of the coupling component, it is possible to ensure the adjustment of the laser focal point position and maintain a stability and consistency of the focal point position even when continuously processing or dynamically adjusting the irradiation angle, thereby improving a size accuracy and a surface quality of the processing component. A laser processing system is more flexible as it quickly adapts to different workpiece thicknesses, material changes, or complex processing routes without the need for frequent manual intervention and adjustment.

Step 530, controlling operation of at least one of a displacement control component, an optical coupling cavity, an angle adjustment component, and a displacement adjustment component based on the at least one group of control instructions for electrochemical deposition.

In some embodiments, the controller may send the control instructions to a corresponding component (e.g., the displacement control component, the optical coupling cavity, the angle adjustment component, the displacement adjustment component, etc.) to control the operation of the corresponding component. For example, the controller may send the control instructions to the displacement control component, and the displacement control component drives at least one of the moving platforms and/or at least one of the rotating platforms to move.

According to some embodiments of the present disclosure, a localized electrochemical deposition additive manufacturing of a 3D complex microstructure under an action of the laser is realized by controlling the operation of at least one of the displacement control component, the optical coupling cavity, the angle adjustment component, and the displacement adjustment component, so as to ensure a processing quality while significantly improving processing efficiency. The process is widely applicable to a manufacture of 3D metal structures at a micrometer scale and provides an effective solution for manufacture needs of metal structures at a micro-scale.

It should be noted that the foregoing descriptions of the process is for the purpose of exemplification and illustration only and does not limit the scope of application of the present disclosure. For those skilled in the art, various corrections and changes to the process may be made under the guidance of the present disclosure. However, these corrections and changes remain within the scope of the present disclosure.

FIG. 6 is a schematic diagram illustrating an exemplary laser angle model according to some embodiments of the present disclosure.

In some embodiments, as shown in FIG. 6, the controller may predict an angle adjustment parameter of an irradiation angle of an optical coupling cavity 630 through a laser angle model 620 based on a moving route 611, each processing position in the moving route and corresponding position information 612, and an initial angle of the optical coupling cavity 613. The controller may further control the angle adjustment component to adjust the irradiation angle of the optical coupling cavity before reaching a target processing position based on the angle adjustment parameter of the irradiation angle of an optical coupling cavity 630.

For more details about the angle adjustment parameter, please refer to the relevant descriptions of FIG. 5.

In some embodiments, the angle adjustment parameter may be represented in various forms, such as a sequence or a matrix. For example, the angle adjustment parameter may be represented in a form of a matrix {(A, t1), (B, t2), (C, t3), . . .}, with the element in (A, t1) of the matrix representing the adjusted irradiation angle at a time t1 at an adjustment position A.

It should be noted that not every irradiation angle corresponding to the processing position needs to be adjusted, and an amount of angle adjustment for the processing position that does not require a change in the irradiation angle is zero.

The target processing position refers to a processing position to be processed where the irradiation angle needs to be adjusted.

The laser angle model is a model used to predict the irradiation angle of the optical coupling cavity of the angle adjustment parameter.

In some embodiments, the laser angle model is a machine learning model. For example, the laser angle model may be a recurrent neural network (RNN) model. The laser angle model may also be a machine learning model of other structures, including one or a combination of convolutional neural network (CNN), deep neural network (DNN), etc.

In some embodiments, an input of the laser angle model may include a moving route, each processing position in the moving route and corresponding position information, and the initial angle of the optical coupling cavity; and an output of the laser angle model may include an angle adjustment parameter for the irradiation angle of the optical coupling cavity.

In some embodiments, the laser angle model may be obtained by training in various feasible ways based on a great count of first training samples with first labels. For example, parameter updates may be performed based on a gradient descent method. An exemplary training process includes: inputting a plurality of first training samples with first labels into an initial laser angle model, constructing a loss function from the first labels and a result of the initial laser angle model; iteratively updating parameters of the initial laser angle model based on the loss function by gradient descent or other methods. The model training is completed when a preset condition is met, and a trained laser angle model is obtained. The preset condition may be that the loss function converges, a count of iterations reaches a threshold, etc.

In some embodiments, the first training samples include at least one group of training samples. Each group of training samples include a sample moving route, a sample processing position for each sample in the sample moving route and corresponding sample position information, and a sample initial angle of the optical coupling cavity. The training samples may be obtained based on historical data or experimental data. The sample initial angle of the optical coupling cavity includes an initial irradiation angle at each sample processing position.

In some embodiments, the first labels may include actual angle adjustment parameters corresponding to the training samples. The first labels may be obtained by the controller or by manual labeling. For example, a plurality of groups of training samples may be formed based on different sample moving routes, different sample processing positions and the corresponding sample position information in the different sample moving routes, and different sample initial angles. The experiment may be repeated for multiple times. For example, for a certain group of training samples, before processing, the controller may take the processing position with a poor processing quality caused by not adjusting the irradiation angle in a timely manner as an adjustment position based on the experimental data, and determine the angle adjustment parameter (hereinafter referred to as artificial angle parameter) of the irradiation angle of the adjustment position based on the manual input; perform processing experiments based on the artificial angle parameter as well as the sample moving route of the group of training samples, each sample processing position of the sample moving route and the corresponding sample position information; and verify a quality of a product after the processing is completed; in response to no quality problem (e.g., a cracks, an inclusion, etc.) occurs, the artificial angle parameter is taken as the first label corresponding to the adjustment position.

In some embodiments, the controller may control the angle adjustment component to adjust the irradiation angle of the optical coupling cavity before reaching the target processing position based on the angle adjustment parameter in various ways. For example, each adjustment position corresponds to an angle adjustment parameter, and the controller may perform a detection based on 3D coordinate points that the probe passes through in the moving route, when the probe is detected to have completed processing at the last 3D coordinate point and is about to enter the next 3D coordinate point. The controller may determine whether the angle adjustment parameter of the processing position corresponding to the next 3D coordinate point is 0. In response to that the angle adjustment parameter is not 0, the controller adjusts the irradiation angle of the optical coupling cavity based on the angle adjustment parameter corresponding to the adjustment position.

In some embodiments of the present disclosure, by adjusting the irradiation angle in advance, interruptions, or quality degradations due to an inappropriate angle are avoided during processing, a time loss due to waiting for the angle to be adjusted is minimized, and the processing efficiency is improved.

FIG. 7 is a schematic diagram illustrating an exemplary angle adjustment model according to some embodiments of the present disclosure.

In some embodiments, a controller may obtain a processing image through a camera during processing; determine a deposition effect based on the processing image; obtain a deposition temperature through a temperature sensor during processing; and further control the angle adjustment component to adjust an irradiation angle of an optical coupling cavity based on the deposition effect and the deposition temperature.

The processing image refers to image data obtained during the processing.

In some embodiments, the controller may be communicatively connected to the camera, and the controller may obtain the processing image through the camera in various feasible ways, including, but not limited to, continuous obtaining, timed obtaining, etc.

The deposition effect is a result of evaluating a formed deposition layer (e.g., a coating, a film, or a structure) during a deposition process. For example, the deposition effect may reflect a thickness condition, a uniformity condition, a presence of bubbles, a presence of cracks, etc. of a deposited material.

In some embodiments, the controller may determine the deposition effect based on the processing image in various ways. For example, the controller may perform a similarity analysis on a current processing image and a plurality of preset images, and determine a reference deposition effect corresponding to the most similar preset image as the current deposition effect. Each preset image corresponds to a reference deposition effect. For example, it may be determined that each preset image corresponds to a reference deposition effect based on a manual evaluation of the processing effect of each preset image.

The deposition temperature refers to a temperature of a deposition region during the process of depositing material.

In some embodiments, the controller may be communicatively connected to the temperature sensor mounted within an electrolytic cell body, and the controller may obtain the deposition temperature in real-time or periodically through the temperature sensor.

In some embodiments, the controller may further control the angle adjustment component to adjust the irradiation angle of the optical coupling cavity based on the deposition effect and the deposition temperature in various ways. For example, when a probe or the electrolytic cell body reaches each new processing position, the controller may determine an update parameter corresponding to the processing position based on the deposition effect and the deposition temperature; and further control the angle adjustment component to adjust the irradiation angle of the optical coupling cavity based on the update parameter.

In some embodiments, the update parameter may be determined based on a preset table or a vector database. Exemplarily, the controller may determine, based on a current parameter combination formed by the deposition effect and the deposition temperature, a reference combination in the preset table that is similar to the current parameter combination, and take the reference combination corresponding to an reference update parameter as the update parameter corresponding to the current parameter combination. The preset table/vector database may include correspondences between the reference update parameter and the reference combination formed by a plurality of deposition effects and a plurality of reference deposition temperatures. The preset table/vector database may be constructed based on prior knowledge or historical data.

In some embodiments, the controller may determine, through the angle adjustment model, the update parameter based on the processing image, the deposition temperature, a current processing position and the corresponding position information, and an angle adjustment parameter.

The update parameter refers to a parameter that adjusts a value of the irradiation angle at a target processing position again. For example, the update parameter may be a sequence including the angle adjustment parameter for the processing position at which the irradiation angle needs to be adjusted again.

In some embodiments, the target processing refers to one or more processing positions after the current processing position that require another adjustment of the irradiation angle.

The angle adjustment model is an algorithm or model for determining the update parameter. In some embodiments, the angle adjustment model is a machine learning model. For example, the angle adjustment model is a machine learning model of a custom structure below. The angle adjustment model may also be a machine learning model of other structures, including one or a combination of a CNN model, an RNN model, a DNN model, etc.

In some embodiments, as shown in FIG. 7, an input of an angle adjustment model 700 includes a processing image 711, a deposition temperature 712, a current processing position and corresponding position information 713, and an angle adjustment parameter 714, and an output includes an update parameter 750.

For more contents about the processing position, the corresponding position information, and the angle adjustment parameter, please refer to the relevant descriptions of FIG. 5.

In some embodiments, the angle adjustment model 700 may include an effect determination layer 720 and an angle adjustment layer 740, as shown in FIG. 7.

The effect determination layer is an algorithm or model used to determine the deposition effect.

In some embodiments, the effect determination layer may be one or a combination of the machine learning models, such as, e.g., the CNN model.

In some embodiments, as shown in FIG. 7, an input of the effect determination layer 720 may include the processing image 711 and a standard deposition image 715, and an output may include a deposition effect 731.

The standard deposition image refers to a processing image for reference. In some embodiments, the controller may screen, based on the historical data, a deposition image whose deposition effect is better under the same or similar processing parameters. In some embodiments, the controller may generate, based on computer simulation software, a deposition image with a better deposition effect under the same or similar processing parameters.

In some embodiments, the effect determination layer may be obtained by training in various feasible ways based on a great count of second training samples with second labels. A manner for training the effect determination layer is similar to the manner for training the laser angle model, and for more details, please refer to the relevant description of FIG. 6.

In some embodiments, the second training samples may include a plurality of sets of training samples, each set of training samples including at least a sample processing image and a sample standard deposition image. The second training samples may be obtained based on the historical data.

In some embodiments, the second label may include a sample deposition effect corresponding to the sample processing image. The second label is obtained by controller labeling or manual labeling. For example, it is possible to manually determine whether a product in the historical data has a quality problem (e.g., defects, cracks, inclusions, etc.), and in response to that there is a quality problem, the second label of the corresponding sample processing image is 0; in response to that there is not a quality problem, the second label of the corresponding sample processing image is 1.

The angle adjustment layer is an algorithm or model used to determine the update parameter.

In some embodiments, the angle adjustment layer may be a machine learning model, such as, one or a combination of the RNN model, etc.

In some embodiments, as shown in FIG. 7, an input of the angle adjustment layer 740 may include the deposition effect 731, the deposition temperature 712, the current processing position and the corresponding position information 713, and the angle adjustment parameter 714, and an output may include the update parameter 750.

In some embodiments, the angle adjustment layer may be trained in various feasible ways based on a great count of third training samples with third labels. A manner for training the angle adjustment layer is similar to the manner for training the laser angle model, and for more details, please refer to the relevant description of FIG. 6.

In some embodiments, the third training samples may include a plurality of groups of training samples, each of which includes at least of a sample deposition effect, a sample deposition temperature, a sample processing position and the corresponding positional information, and a sample angle adjustment parameter, and the third training samples may be obtained based on the historical data. A sample moment refers a historical moment at which the updated parameters need to be determined.

In some embodiments, the third label may include an actual update parameter corresponding to the third training sample. The third label may be obtained based on manual or automatic labeling. For example, a plurality of candidate update parameters may be obtained by performing a fine-tuning based on the angle adjustment parameter by manual judgment, and subsequent processing may be respectively performed based on a plurality of candidate fine-tuned angles, together with the sample deposition effect, the sample deposition temperature, the processing position at the sample moment, and the corresponding position information; and the manual judgment on whether a processed product has a quality problem (e.g., a defect, a crack, an inclusion, etc.) may be performed, and in response to that there is no quality problem, then the corresponding candidate update parameter may be used as the third label.

It should be noted that the laser angle model is used before processing. The laser angle model predicts the adjusted irradiation angle of the adjusted position through calculation or simulation based on a demand of a processing task, a moving route, each processing position in the moving route, the corresponding position information, and the initial angle of the optical coupling cavity, etc. The laser angle model provides a theoretical value for the processing process to ensure that processing conditions are as close as possible to ideal processing conditions from the very beginning of the process. The angle adjustment model is a dynamic adjustment strategy used for many times in the actual processing process. The angle adjustment model adjusts the irradiation angle of the laser or other energy sources at the current processing position in a timely manner based on data collected in real-time during the processing (such as the processing image obtained from the camera, the deposition temperature monitored by the temperature sensor, etc.). The angle adjustment model emphasizes adaptability and precise control of the process. Through continuous feedback and correction, the angle adjustment model ensures that the deposition process is able to cope with various practical changes and continuously optimize the deposition effect.

In some embodiments of the present disclosure, by adjusting and updating the irradiation angle of the optical coupling cavity in real-time, the device is able to perform more detailed angle fine-tuning based on the updated parameter, so as to optimize specific localities or details and achieve more precise deposition control, thereby improving product precision and quality.

One or more embodiments of the present disclosure further provide a controlling device for laser induced electrochemical deposition. The device includes a processing apparatus used to perform the controlling method for laser induced electrochemical deposition as described in any of the preceding embodiments.

One or more embodiments of the present disclosure further provide a non-transitory computer-readable storage medium storing computer instructions. When executing the computer instructions in the non-transitory computer-readable storage medium, a computer implements the method for laser induced electrochemical deposition as described in any one of the preceding embodiments.

As shown in FIG. 1, the embodiment discloses a laser induced electrochemical deposition five-axis additive manufacturing device. The device includes a housing, together with a main support component 1, a five-axis displacement control component (also referred to as a displacement control component) 2, a three-electrode component (also be referred to as an electrode component) 4, and a coupling component for laser induced electrochemical deposition (also referred to as a coupling component) 5 disposed inside the housing.

The five-axis displacement control component 2 is fixed to the main support component 1 and is configured to control the coupling component for laser induced electrochemical deposition 5 to move in a Z-axis direction and to control the electrolytic cell body 401 to move in an X-axis direction, a Y-axis direction, and to rotate about the Z-axis, and the X-axis direction;

The three-electrode component 4 and the coupling component for laser induced electrochemical deposition 5 are both fixedly connected to the five-axis displacement control component 2. Based on the five-axis displacement control component 2, the coupling component for laser induced electrochemical deposition 5 and the three-electrode component 4 are disposed in a same longitudinal axis sequentially from top to bottom.

In some embodiments, as shown in FIG. 1, the main support component 1 includes the optical vibration isolation platform 101 and the gantry 102.

The gantry 102 is fixed to the optical vibration isolation platform 101.

In some embodiments, as shown in FIG. 2, the five-axis displacement control component 2 includes: an X-axis moving platform (also referred to as a first moving platform) 201, a Y-axis moving platform 202 (also referred to as a second moving platform), a Z-axis moving platform 203 (also referred to as a third moving platform), an X-axis rotating platform 204 (also referred to as a first rotating platform), and a Z-axis rotating platform 205 (also referred to as a second rotating platform). The Z-axis moving platform 203 is fixed to mounting holes in a side wall of the gantry 2. The X-axis moving platform 201 is fixed to the optical vibration isolation platform 101 by threaded holes for fixing a distance on the optical vibration isolation platform 101. The Y-axis moving platform 202 is mechanically connected to a top surface of the X-axis moving platform 201. The Z-axis rotating platform 205 is mechanically connected to a top surface of the Y-axis moving platform 202. The X-axis rotating platform 204 is mechanically connected to a top surface of the Z-axis rotating platform 205.

In some embodiments, a laser induced electrochemical deposition five-axis additive manufacturing device further includes a visualization component 3. The visualization component 3 is mechanically connected to the optical vibration isolation platform 101 for observing a working process within the electrolytic cell body 401.

In some embodiments, the visualization component 3 includes: a camera stand 301 and a camera 302. The camera stand 301 is mechanically connected to the optical vibration isolation platform 101. The camera 302 is mechanically connected to the camera stand 301.

As shown in FIG. 1, the three-electrode component 4 includes: an electrolytic cell body 401, an electrochemical workstation 402, and a signal connecting line 403. The electrolytic cell body 401 is mechanically connected to the top surface of the Z-axis rotating platform 205. The electrochemical workstation 402 is fixed to the optical vibration isolation platform 101. The electrochemical workstation 402 is in a three-electrode connection to the electrolytic cell body 401 through the signal connecting line 403.

In some embodiments, as shown in FIG. 3, the coupling component for laser induced electrochemical deposition 5 includes: a coupling cavity fixture 507, together with an optical coupling cavity 505, a first focusing lens 504, an electrolyte reservoir 503, and a probe 501 disposed in sequence in a same longitudinal axis. The optical coupling cavity 505, the first focusing lens 504, and the electrolyte reservoir 503 are connected optically in sequence. The electrolyte reservoir 503 is fixedly connected to the probe 501. Specifically, the probe 501 is connected to a liquid outlet disposed on a bottom of the electrolyte reservoir 503 so that the electrolyte is extruded from an outlet of the probe 501. Alternatively, in this embodiment, the electrolyte reservoir 503 is provided with an electrolyte inlet 502 on a side wall. One end of the coupling cavity fixture 507 clamps the electrolyte reservoir 503 and the other end is movably connected to the Z-axis moving platform 203, thereby making the coupling component for laser induced electrochemical deposition 5 move in the Z-axis direction. Specifically, in this embodiment, the optical coupling cavity 505 is fixed to the Z-axis moving platform 203 through the coupling cavity fixture 507 and the locking screw 506.

In some embodiments, as shown in FIG. 4, the optical coupling cavity 505 consists of a laser 505-1, a beam extension system 505-2, a diaphragm 505-3, and a second focusing lens 505-4 that are connected optically in sequence with a same longitudinal axis.

In some embodiments, the method for laser induced electrochemical deposition using the laser induced electrochemical deposition five-axis additive manufacturing device is adopted. The method includes the following steps.

A working electrode, a reference electrode, and a counter electrode of the electrochemical workstation 402 are connected to a working electrode terminal, a reference electrode terminal, and a counter electrode terminal of an electrolytic cell body correspondingly via the signal connection line 403 for electrochemical deposition.
The following is an exemplary illustration of the electrochemical deposition process in Steps 1-11:

Step 1: taking a nickel sulfate crystal and ultrapure water, preparing a nickel sulfate solution with a concentration of 1 mol/L, using a H3BO3 solution to create an acidic environment, adjusting a solution PH to 5, taking 50 ml of the solution for the experiment, 50 ml of the solution for spare; preparing 100 ml of a dilute sulfuric acid and dilute hydrochloric acid mixed solution with a solution PH of 5 as a support solution, taking an appropriate amount of polyethylene glycol crystals, preparing a polyethylene glycol solution to be used as an electrodeposition additive.
Step 2: preparing three electrodes of the three-electrode component, sanding the working electrode with a 2000-mesh sandpaper, then polishing the working electrode, and washing it with deionized water for 3 minutes until a surface of the electrode is clean; gently rinsing the reference electrode and the counter electrode with the deionized water until the electrode surface is clean.
Step 3: zeroing the X-axis moving platform, the Y-axis moving platform, the Z-axis moving platform, the X-axis rotating platform, and the Z-axis rotating platform respectively, installing the electrolytic cell body on the Z-axis rotating platform, fixing the electrolytic cell body directly below the probe and leveling it, so as to facilitate a vertical incidence of the electrolyte and the laser onto the working electrode.
Step 4: adding 20 ml of the dilute sulfuric acid and dilute hydrochloric acid mixed solution with the PH of 5 to the electrolytic cell body 401, and adding a 1 mol/L mixed solution of nickel sulfate and H₃BO₃ to the electrolyte reservoir by a pressure pump to provide a raw material for the experiment.
Step 5: turning on a D-camera and a white light source, and adjusting a distance between the probe and the working electrode to a spacing of 10 microns.
Step 6: turning on the laser and adjusting a spot position so that a center of the spot coincides with a center of a probe opening; setting the laser parameter and adjusting the defocus amount to make sure that a high laser power does not damage the working electrode; then shutting down the laser 505-1.
Step 7: connecting a power supply of the electrochemical workstation, connecting a signal connection line between the electrochemical workstation and the electrolytic cell body, testing whether a hardware of the electrochemical workstation is working normally, selecting an experimental method, and setting experimental parameters.
Step 8: importing a written moving route code into a computer, testing whether the moving route is accurate, after confirming that a scanning path is correct, zeroing a precision displacement system, and preparing to start the experiment.
Step 9: turning on a laser switch, an electrochemical workstation run button, and a five-axis displacement control component switch; checking whether each portion of the device is operating normally, and starting the experiment after making sure that no error occurs.
Step 10: observing experimental phenomena at regular intervals during the experimental process, and recording experimental data such as a current density, a camera picture collection, etc., to ensure that the experimental process is correct and orderly.
Step 11: completing the experiment, saving the experimental data, turning off the laser, the electrochemical workstation, and the five-axis displacement control component switch; cutting off the power supply of each experimental equipment; arranging the experimental apparatus, cleaning the electrolytic cell body, the electrolyte reservoir, and the three electrodes; putting away the experimental equipment for next use.

Through the experimental method described above, the present embodiment brings about the following beneficial effects: utilizing a laser induced electrochemical deposition five-axis additive manufacturing device and method, a 2D planar pattern, a 2.5D columnar structure, and a 3D complex metal structure manufacture at a micrometer scale of 10 microns-500 microns are implemented. In the technical method, based on advantages of layer-by-layer manufacture of the electrochemical deposition, a manufacture efficiency and a manufacture quality of the microstructures are significantly improved under laser coupling, which provides a potential solution to a great demand for microstructures in fields of microelectronics, a chip heat dissipation, a biosensing, and optical hypersurfaces. Meanwhile, the technical method enriches and expands the existing technological solutions and process of the additive manufacturing.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, or amendments to the present disclosure. These types of modifications, improvements, or amendments are suggested in the present disclosure, so these types of modifications, improvements, or amendments remain within the spirit and scope of the exemplary embodiments of the present disclosure.

Also, the present disclosure uses specific words to describe embodiments of the present disclosure. For example, “an embodiment,” “one embodiment,” and/or “some embodiments” mean a feature, structure, or characteristic associated with at least one embodiment of the present disclosure. Accordingly, it should be emphasized and noted that “an embodiment” or “one embodiment” referred to two or more times in different positions in the present disclosure, or “an alternative embodiment,” do not necessarily refer to the same embodiment. In addition, certain features, structures, or characteristics of one or more embodiments of the present disclosure may be suitably combined.

In addition, unless expressly stated in the claims, the order of the processing elements and sequences, the use of numerical letters, or the use of other names as described in the present disclosure are not intended to qualify the order of the processes and methods of the present disclosure. While some embodiments of the present disclosure that are considered useful are discussed in the foregoing disclosure by way of various examples, it should be appreciated that such details serve only illustrative purposes, and that additional claims are not limited to the disclosed embodiments. Rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments of the present disclosure, the foregoing descriptions of embodiments of the present disclosure sometimes group multiple features together in a single embodiment, accompanying drawings, or in a description thereof. However, this method of disclosure does not imply that the objects of the present disclosure require more features than those mentioned in the claims. Rather, claimed subject matter may lie in less than all features of a single foregoing disclosed embodiment.

Some embodiments use counts to describe the count of components or attributes, and it should be understood that such counts used in the description of the embodiments are modified in some examples by the modifiers “about,” “approximately,” or “substantially”. Unless otherwise noted, the terms “about,” “approximate,” or “approximately” indicate that +20% variation in the stated count is allowed. Correspondingly, in some embodiments, the numerical parameters used in the present disclosure and claims are approximations, which approximations are subject to change depending on the desired characteristics of individual embodiments. In some embodiments, the numerical parameters should consider the specified count of valid digits and employ general place-keeping. While the numerical domains and parameters used to confirm the breadth of their ranges in some embodiments of the present disclosure are approximations, in specific embodiments such values are set to be as precise as possible within a feasible range.

For each of the patents, patent applications, patent application disclosures, and other materials cited in the present disclosure, such as articles, books, specification sheets, publications, documents, etc., are hereby incorporated by reference in their entirety into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that to the extent that there is an inconsistency or conflict between the descriptions, definitions, and/or use of terms in the materials appurtenant to the present disclosure and those set forth herein, the descriptions, definitions, and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be considered consistent with the teachings of the present disclosure as an example, not as a limitation. Accordingly, the embodiments of the present disclosure are not limited to the embodiments expressly presented and described herein.

What is claimed is:

1. A laser induced electrochemical deposition five-axis additive manufacturing device, including: a housing, together with a main support component, a displacement control component, an electrode component, and a coupling component that are disposed inside the housing; wherein
the displacement control component is fixed to the main support component, and is configured to control the coupling component to move in a third direction, and/or control a partial structure of the electrode component to move in a first direction and a second direction, and to rotate about the first direction and the third direction; and
the electrode component and the coupling component are both fixedly connected to the displacement control component; the coupling component and the electrode component are mounted in sequence on the displacement control component along the third direction.

2. The device of claim 1, wherein the main support component includes: an optical vibration isolation platform and a gantry; wherein the gantry is fixed to the optical vibration isolation platform.

3. The device of claim 2, wherein the displacement control component includes: a first moving platform, a second moving platform, a third moving platform, a first rotating platform, and a second rotating platform; wherein
the third moving platform is fixed to mounting holes in a side wall of the gantry;
the first moving platform is fixed to the optical vibration isolation platform through threaded holes in the optical vibration isolation platform;
the second moving platform is mechanically connected to the first moving platform;
the second rotating platform is mechanically connected to the first rotating platform; and
the first rotating platform is mechanically connected to the second moving platform.

4. The device of claim 3, wherein the electrode component includes: an electrolytic cell body, an electrochemical workstation, and signal connection lines; wherein the electrolytic cell body is mechanically connected to the second rotating platform;
the electrochemical workstation is fixed to the optical vibration isolation platform; and
the electrochemical workstation is in a three-electrode connection to the electrolytic cell body through the signal connection lines.

5. The device of claim 3, wherein the coupling component includes: a coupling cavity fixture and an optical coupling cavity, a first focusing lens, an electrolyte reservoir, and a probe disposed in sequence in the third direction; wherein
the optical coupling cavity, the first focusing lens, and the electrolyte reservoir are connected optically in sequence;
the electrolyte reservoir is fixedly connected to the probe;
one end of the coupling cavity fixture clamps the electrolyte reservoir, and the other end is movably connected to the third moving platform to enable the coupling component to move in the third direction.

6. The device of claim 5, wherein the optical coupling cavity includes a laser, a beam extension system, a diaphragm, and a second focusing lens connected optically in sequence in the third direction.

7. The device of claim 2, further including a visualization component; wherein
the visualization component is mechanically connected to the optical vibration isolation platform.

8. The device of claim 7, wherein the visualization component includes: a camera stand and a camera; wherein
the camera stand is mechanically connected to the optical vibration isolation platform; and
the camera is mechanically connected to the camera stand.

9. The device of claim 1, wherein the device further includes a controller, and the displacement control component further includes a driving motor; wherein
the controller is configured to:
send a displacement instruction to control the displacement control component to drive at least one of the first moving platform, the second moving platform, and the third moving platform, and/or at least one of the first rotating platform and the second rotating platform to perform a displacement based on the driving motor.

10. The device of claim 9, wherein the device further includes a level sensor component, the level sensor component being mechanically connected to the electrolytic cell body, and the level sensor component being configured to monitor an inclination of the electrolytic cell body.

11. The device of claim 7, wherein the coupling component further includes an angle adjustment component mechanically connected to the optical coupling cavity and communicatively connected to the controller;
the controller is further configured to:
send an angle adjustment instruction to control the angle adjustment component to adjust an irradiation angle of the optical coupling cavity.

12. The device of claim 11, wherein the controller is further configured to:
predict an angle adjustment parameter of the irradiation angle of the optical coupling cavity through a laser angle model based on a moving route, each processing position in the moving route and corresponding position information, and an initial angle of the optical coupling cavity, the laser angle model being a machine learning model; and
control the angle adjustment component to adjust the irradiation angle of the optical coupling cavity before reaching a target processing position based on the angle adjustment parameter of the irradiation angle.

13. The device of claim 11, wherein the controller is further configured to:
obtain a processing image through a camera during processing;
determine a deposition effect based on the processing image;
obtain a deposition temperature through a temperature sensor during processing; and
further control the angle adjustment component to adjust the irradiation angle of the optical coupling cavity.

14. The device of claim 8, wherein the optical coupling cavity further includes a displacement adjustment component mechanically connected to the optical coupling cavity and communicatively connected to the controller, and the displacement adjustment component is configured to adjust a position of the optical coupling cavity in the third direction;
the controller is further configured to:
send a focus adjustment instruction in response to a change of the irradiation angle to control the optical coupling cavity to adjust a laser defocus amount.

15. The device of claim 14, wherein the controller is further configured to:
determine a displacement of the optical coupling cavity in the third direction based on the displacement of the coupling component in the third direction, and the angle adjustment parameter through a preset algorithm; and
control the optical coupling cavity to adjust the laser defocus amount based on the displacement of the optical coupling cavity in the third direction.

16. A method for laser induced electrochemical deposition, wherein the method comprises:
connecting a working electrode, a reference electrode, and a counter electrode of an electrochemical workstation to a working electrode terminal, a reference electrode terminal, and a counter electrode terminal of an electrolytic cell body correspondingly via signal connection lines for electrochemical deposition.

17. A controlling method for laser induced electrochemical deposition, wherein the method is performed by a controller, and the method comprises:
determining a processing parameter, the processing parameter including at least one of a moving route, at least one processing position and corresponding position information, and a laser processing parameter;
determining at least one group of control instructions based on the processing parameter, and
controlling operation of at least one of a displacement control component, an optical coupling cavity, an angle adjustment component, and a displacement adjustment component based on the at least one group of control instructions for electrochemical deposition.

18. The method of claim 17, wherein the controlling operation of at least one of a displacement control component, an optical coupling cavity, an angle adjustment component, and a displacement adjustment component based on the at least one group of control instructions includes:
sending a displacement instruction to control the displacement control component to drive at least one moving platform and/or at least one rotating platform to perform a displacement based on a driving motor.

19. The method of claim 17, wherein the controlling operation of at least one of a displacement control component, an optical coupling cavity, an angle adjustment component, and a displacement adjustment component based on the at least one group of control instructions includes:
sending an angle adjustment instruction to control the angle adjustment component to adjust an irradiation angle of the optical coupling cavity.

20. The method of claim 17, wherein the controlling operation of at least one of a displacement control component, an optical coupling cavity, an angle adjustment component, and a displacement adjustment component based on the at least one group of control instructions includes:
sending a focus adjustment instruction in response to a change of the irradiation angle to control the optical coupling cavity to adjust a laser defocus amount.
